(19) United States
(12) Patent Application Publication
(10) Pub. No.: US 2021/0133631 A1
(43) Pub. Date: May 6, 2021

(54) COMPUTER METHOD AND SYSTEM FOR AUTO-TUNING AND OPTIMIZATION OF AN ACTIVE LEARNING PROCESS

(71) Applicant: Alectio, Inc., Santa Clara, CA (US)

(72) Inventor: Jennifer Laetitia Prendki, Mountain View, CA (US)

(21) Appl. No.: 17/084,309

(22) Filed: Oct. 29, 2020

Related U.S. Application Data
(60) Provisional application No. 62/928,278, filed on Oct. 30, 2019.

(51) Int. Cl. G06N 20/00; G06F 16/23

(52) U.S. Cl. CPC G06N 20/00; G06F 16/2379

(57) ABSTRACT

In one embodiment, a method includes a procedure for the Auto-Tuning and Optimization of an Active Learning Process including receiving unlabeled training set data; processing the unlabeled training set data using a selection process to yield a labeled training set; training a machine learning model using the labeled training set; inferring metadata elements from the model and storing metadata based on the model; iterating the foregoing steps two or more times, including using the metadata to influence how other unlabeled training set data is selected; all of the foregoing implementing one or more of: data and model privacy; optimal initialization; early abort; multi-loop querying strategy; dynamic-evolving querying strategy; querying strategy memorization; optimization and tuning.

### BENEFIT CLAIM

This application claims the benefit under 35 U.S.C. 119(e) of provisional application 62/928,278, filed Oct. 30, 2019, the entire contents of which are hereby incorporated by reference for all purposes as if fully set forth herein.

### TECHNICAL FIELD

One technical field of the disclosure is computer-implemented artificial intelligence and machine learning. Another technical field is computer-implemented AWL model training using large datasets. Related fields include Big Data, De-noising, Machine Learning Lifecycle Management, Data Curation, and Training Set Optimization.

### BACKGROUND

The recent explosion in the number of real-life machine learning (“ML”) applications and products, such as facial recognition systems or autonomous vehicles is closely related to the emergence of so-called “Big Data.” Think, for example, that most of the theoretical framework behind the technique known as deep learning has been around since the 1940's, but that it is only recently that data scientists and ML experts have been able to leverage it in practice. To learn the many parameters involved in the complicated architectures of Deep Learning, models require both a lot of computing power and a lot of data.

This tendency for data scientists to keep increasing the size of their training sets comes from the core belief that more is better, and that hardware will continuously “scale” to compensate for the growth of the datasets involved in ML. Also, data scientists have been conditioned for years to hoard data because historically obtaining enough data was difficult and time-consuming.

Now that data is prolific, injecting all available data in models is unnecessary and wasteful of computing resources such as CPU cycles, memory, storage, and network bandwidth. Using excess data and static data collection processes, where data is collected well before the application is determined, are often responsible for model anomalies, because they both cause biases in the model.

### SUMMARY OF PARTICULAR EMBODIMENTS

The claims may serve as a summary of the invention.

### BRIEF DESCRIPTION OF THE DRAWINGS

FIG. 1 illustrates a prophetic example learning curve showing the intent of the user of Active Learning.

FIG. 2 illustrates a flow of the Active Learning process.

FIG. 3 illustrates features of the disclosed system.

FIG. 4 illustrates an example computer system.

### DESCRIPTION OF EXAMPLE EMBODIMENTS

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

One of the biggest costs of preparing data for machine learning is data labeling. In past practice, data labeling is an error-prone, time-consuming process, which is still mostly done manually by individuals or through crowdsourcing. It is also difficult for the customer and owner of the data to validate the quality of the labels generated, and in many cases, the labelers have to be expensive, trained experts such as doctors, surgeons, or lawyers.

Embodiments described herein include a computer-implemented process that is programmed for automating the discovery of an optimal querying strategy to use to train a specific model with a specific dataset using Active Learning. Active Learning is a technique that has been used, especially in academic circles, to reduce the volume of labels required to train a model. Active Learning is an approach/methodology belonging to a type of algorithm called Semi-Supervised Machine Learning. Active Learning is a subset of Semi-Supervised Machine Learning allowing to dynamically (actively) identify the data that should be labeled. Active Learning is a trial-and-error process which consists in “growing” a dataset dynamically by monitoring the meta-data generated by the model, in a way that data with the most useful information is prioritized over the rest. Because it involves a trial-and-error process, it is prone to incur compute power costs while reducing the number of labels. Therefore, it is not widely adopted in the industry, where compute power costs actually compete with labeling costs.

Active Learning may act as a wrapper around a Supervised Machine Learning algorithm using an incremental training approach to dynamically form an optimized training set by prioritizing the records in the original unlabeled training set by order of informational value. By prioritizing the data that contains the most relevant information and avoiding the data that contains either irrelevant or redundant information, Active Learning allows the process to reach a similar, or even better accuracy than one that would be obtained by training a model on the entire training set as is common in previous techniques.

The first purpose of Active Learning is to reduce the quantity of data that needs to be labeled to train the model. It is particularly useful in fields and use cases where labeling is very expensive. In one example, the labeling process would be expensive and onerous because it requires the expertise of medical doctors, surgeons, or other subject-matter experts, or another expensive process, such as, for example, an MRI or a battery of medical tests.

Active Learning as a well-understood approach is still in its infancy, development-wise, and requires manual tweaking and tuning. This tweaking and tuning are generally of a nature similar to hyperparameter tuning for Deep Learning. There is no readily available framework on the market to support ML scientists with no preliminary experience in Active Learning in finding the perfect querying strategy. A common assumption in Active Learning is that a single, static querying strategy should be picked and maintained throughout the entire process. This disclosure includes various features allowing the efficient automation of Active Learning processes.

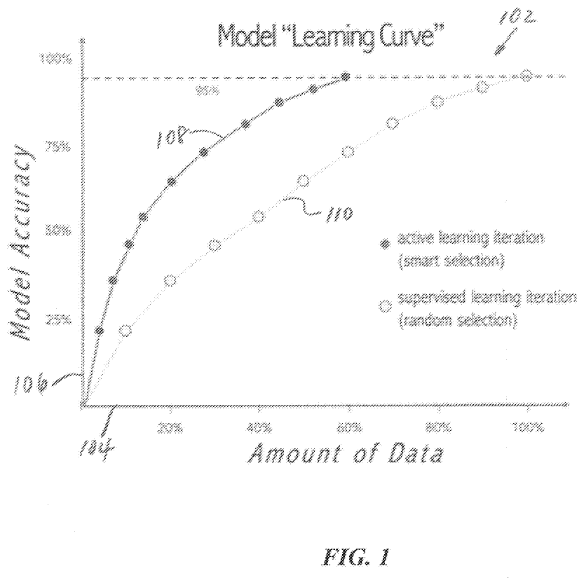

FIG. 1 illustrates a prophetic example learning curve showing the intent of the user of Active Learning. In FIG. 1, a learning curve 102 comprises an X axis 104 representing an amount of data used in machine learning, denoted as percentage of data, and a Y axis 106 specifying increasing model accuracy. In a first approach, with supervised learning and random selection of data for learning, a relatively flat first learning curve 110 indicates that training on a substantial percentage of the data is necessary to achieve high model accuracy. In contrast, a steeper second learning curve 108 yields greater model accuracy after training with much less data, about 60% versus 100% for the first curve 110. That is, prioritizing the most informational data causes the accuracy of the model to increase faster, and higher accuracies are reached with significantly less data.

Reinforcement Learning is a paradigm in Machine Learning that includes maximizing some notion of cumulative reward instead of explicitly learning from historical data. Instead, Reinforcement Learning focuses on finding a balance between the exploration of uncharted territory and the exploitation of its current knowledge. While basic applications of Reinforcement Learning are available, particular embodiments of this disclosure include the usage and combination of Reinforcement Learning with Active Learning in order to dynamically discover a querying strategy.

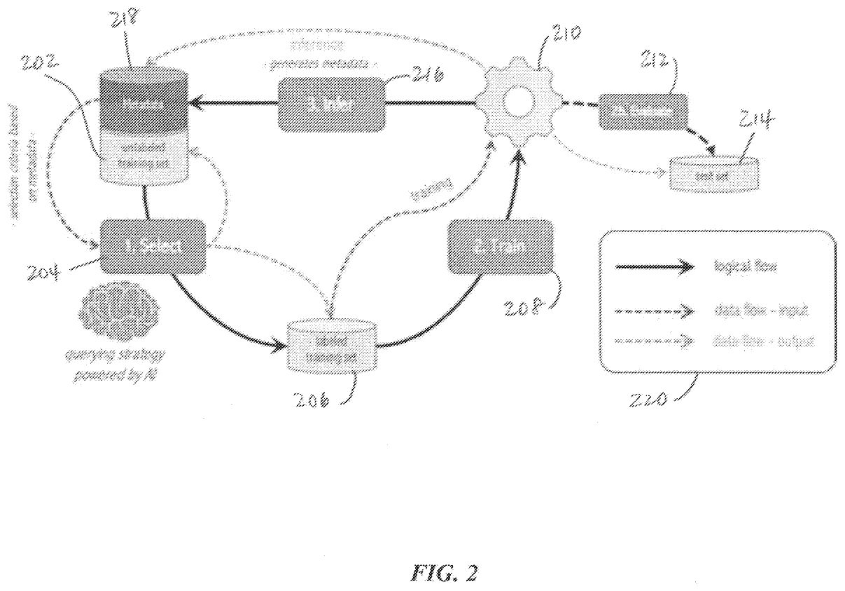

FIG. 2 illustrates a flow of the Active Learning process. In an embodiment, the process of FIG. 2 is implemented in stored program instructions for a computer in which a querying strategy in the Active Learning process is computed using artificial intelligence and machine learning. The artificial intelligence replaces the common procedure of leaving the decision of the querying strategy to a human in charge of the process. The querying strategy can be dynamic and evolve across the process. Using artificial intelligence to make this decision provides improvements over previous techniques that used Active Learning by making such learning reactive to the process itself in a manner that could not be achieved by a procedure relying on human interaction.

As an overview, in one embodiment, unlabeled training set data 202 is processed using a Select stage 204 to yield a labeled training set 206. In a Training stage 208, a machine learning model 210 is trained using the labeled training set 206. The model may be evaluated in an Evaluate stage 212 using a test set 214 of data to determine the effectiveness of the model. In an Infer stage 216, metadata elements are inferred from the model and generated, being stored as metadata 218. The process may iterate and repeat in the same manner. In second or later iterations, the metadata 218 may influence how additional or newly received unlabeled training set data is selected at Select stage 204. Consequently, later training at Train stage 208 is improved. Furthermore, human labeling of data is eliminated by using inferred metadata to guide or control the labeling of later received data.

Embodiments described herein include a computer-implemented process that is programmed for automating the discovery of an optimal querying strategy to use to train a specific model with a specific dataset using Active Learning. By prioritizing the data that contains the most relevant information and avoiding the data that contains either irrelevant or redundant information, Active Learning allows the process to reach a similar, or even better accuracy than one that would be obtained by training a model on the entire training set as is common in previous techniques. Standard approaches to Active Learning typically require manual tuning by a human before it can be used. If the Active Learning process is not tuned properly, it may lead to worse results than those of Supervised Machine Learning, that is, training on the entire dataset. Because of this, a significant number of ML researchers who attempt to use Active Learning abandon the technique. Any available techniques providing Active Learning as a service rely on a static approach which is not tuned to the use case, model or dataset, and hence, which leads to disappointing results.

Embodiments of this disclosure provide benefits including, but not limited to, one or more of: enabling ML scientists with no prior knowledge of Active Learning to train their models using an appropriate querying strategy; dynamically updating and continuously optimizing the querying strategy, as well as the loop size; optimizing Active Learning parameters to a user's model and dataset; considering a user's constraints (in time and budget) to identify stopping criteria as well as other parameters, such as the number of loops, and the size of the loops; proactively identifying “false starts” and aborting the Active Learning process to restart from scratch as necessary.

Throughout this disclosure, the following terms are used. Ground Truth refers to the real “label” of a data point; in the case of classification, the real “class” that a data row belongs to. Data row refers to a “data record” or one entry in a dataset. Split refers to separation of a dataset used in Machine Learning into a training set (used for learning) and test set (used to measure accuracy and model performance). Hold-out refers to a sample that is not used to train a model; it is kept separate from the training set so that any performance measurement is not biased due to the fact the model implements memorization of the training set it learns with rather than generalization to all data. Querying strategy refers to the sampling strategy used to determine the next batch of data to be used when training the ML algorithm over the next iteration/loop. Such querying strategies usually rely on metadata generated during the previous iteration/loop. Note that this disclosure also proposes an approach where the entire past “history” can be used.

Active learning begins with an unlabeled dataset, which is split into a training set and a test set. The test set is labeled, in order to be able to measure the accuracy of the model at each loop. A training set is initialized. Initialization includes selecting a small sample of the training set. If the data is used as a black box, it is randomly sampled, or sampled using stratified sampling. The quantity of data chosen at this point (size of loop #0) is one of the parameters that, in previous techniques, must be manually decided by the ML scientist in charge of the training process. “Loop 0” is trained. The model is trained with this initial sample S₀ included in S (entire training set). The accuracy can be measured on the test set.

Inference is derived from loop 0. The subsequent model (m₀) is used to run inferences on the unused part of the training set, S \ S₀. The inference process generates metadata such as confidence level, margin, entropy, etc. In one variation multiple models are used metadata collected from all training processes. Because the remaining data (on which the inferences are run) is unlabeled, it is not possible to see what is correctly predicted or not, but rather, what was easily/confidently predicted (for example, because the confidence level of the prediction is high, or because multiple different models lead to the same prediction). Sample selection is performed on “loop 1.” Using a predetermined querying strategy (sample method based on the metadata), a new subset S₁, a subset of S \ S₀ of the remaining training set is chosen to be added to S₀; the union of S₀ and S₁, the intersection of S₀ and S₁ may now be used as the new training set. Training is then performed on loop 1. The model is re-trained, the subsequent model is now called m₁. The process continues iteratively.

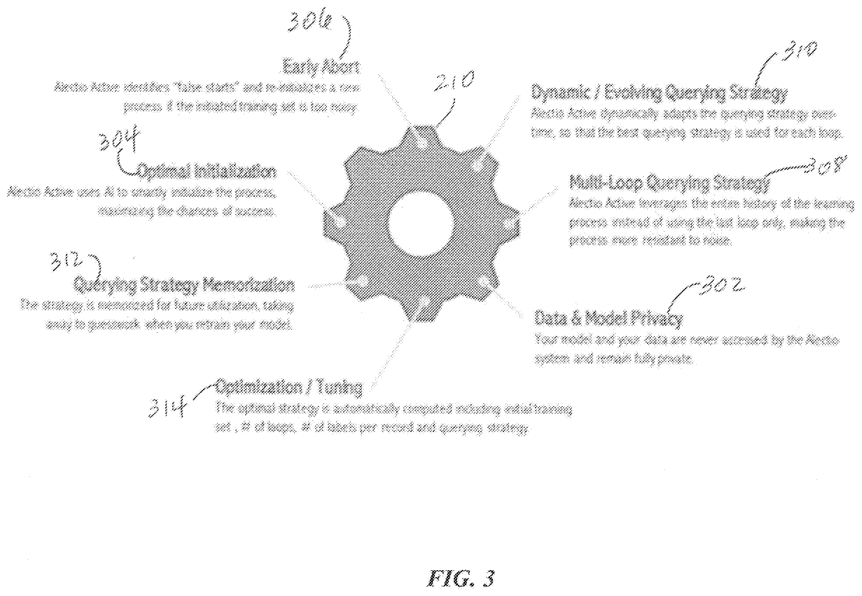

FIG. 3 illustrates features of the disclosed system. In an embodiment, the system of FIG. 2 is improved by integrating the features of FIG. 3 in stored program instructions as part of model 210.

The features include: Data and Model Privacy 302. Active Learning traditionally relies on metadata rather than raw data. Data and Model Privacy 302 is an important part of the disclosed system because many users are sensitive to sharing their data and/or code. The system allows customers to run an Active Learning process on their model without having to directly share their model/code and/or their data with a service provider. The disclosed system identifies, tunes and optimizes the Active Learning process without accessing the data or the model. Instead, the disclosed system learns and makes decisions based on the metadata that is generated during each loop within the training process to infer the most informational data. This assume that a service provider can sample the data and feed specific samples into the customer models without directly accessing either one of them. All that is needed is a way to refer to specific records (i.e., IDs for each data record) and an API to retrain the model with samples. When an end user agrees to share data, a more informed initialization of the Active Learning process can be done. This diminishes the likelihood of a false start, as if the initial sample is taken to be particularly poor in valuable information, or contains a lot of redundancy, it is possible that the process will be quickly “stalled” and/or lead to disappointing results.

The features include: Optimal Initialization 304. The initialization step refers to the selection of the very first sample that will be used to train the Machine Learning model the first time. The first loop is referred to as loop #0 to emphasize that this first loop is different from the others because at first no information is known about that. The data is originally unlabeled, and that the system assumes that the customer hasn't shared the actual data with the system and is only providing selection of the records that will be used to train the model incrementally. In some cases, an end user is willing to allow the system to see the data, which means that the nature and the content of the data is actually visible. In this embodiment, the system may be aware of the features that are used in the model. Thus, it is possible to use various clustering techniques in order to ensure a more balanced sample by making sure that all the data that gets selected during the initialization is not located in the same area of the feature space.

The features include: Early Abort 306. As stated above, if the Active Learning process is initialized randomly with no knowledge of the distribution of the selected data in the feature space, there is a risk that the Active Learning process will not be successful. For example, if a specific class in overrepresented, the model might quickly converge to the conclusion that all records belong to the same class, and the process will lead to an infinite loop which it is impossible to get out of Relying on the real-time monitoring of the learning curve, the confusion matrix and other metrics, the disclosed system identifies early on clues that indicate that the process is unlikely to yield good results, so that the process can be aborted and re-initialized by selecting a different initial sample.

The features include: Multi-Loop Querying Strategy 308. In some Active Learning approaches, the querying strategy consists of identifying an optimal subset of unused records to add to the training set based on the information/metadata that was generated during the training of the previous loop (iteration), i.e., the metadata generated during the inference step of loop n is used to select the additional records (which will be labeled) during loop (n+1). In this the disclosure system, the entire metadata that was generated prior to loop (n+1) is used instead of merely relying on the previous “ancestor”. The rationale is that some records which haven't been queried yet can be observed to be inferred with a gradual improvement in confidence, which signals that this record is benefitting from the information that has been learned from other records. On the other hand, if a record, which hasn't been queried yet at loop (n+1) is consistently predicted with a similar confidence level, it is a sign that the information that it contains is unique and that it won't be learned unless it is used in the training set.

The features include: Dynamic/Non-Static Querying Strategy 310. In some Active Learning processes, the same querying strategy is used (that which was predetermined before starting the process) across the entire process. There is, in fact, no reason to apply the same querying strategy at each step/loop, and there is also no reason to use the same loop size. Instead of predetermining and fixing parameters such as loop size, loop number, querying strategy, etc., the disclosed system reassesses them at the end of each loop, continuously. It is reasonable to suspect that a querying strategy that might lead to great results over the first loops might turn out not to be so great later in the process. It is also possible that using the same, static querying strategy might lead to oversampling in specific areas of the feature space, and hence lead to biases. Querying strategies are treated as dynamic, evolving objects that are best re-assessed on a continuous basis taking into account all the information/metadata associated with the learning process of the model.

The features include various Querying Strategy Paths (QSP) and Querying Strategy Generalization, or Querying Strategy Memorization 312 and Optimization/Tuning 314. A first strategy includes a greedy strategy to construct a dynamic querying strategy. Contrary to general belief, querying strategies do not need to be treated as mathematical formulae, but rather, as sampling functions that take as an input the metadata generated by during the previous loops. One querying strategy is based on the use of the confidence level with which the unused training data was predicted during the previous loop. A sample algorithm of as much is shown below:

Example Algorithm: Confidence Level-Based Querying Strategy
Take the entire unlabeled dataset D and split into the training set S and the test set T
Initialize set of unused data records U to S: U=S
Initialize active training set A to the empty set
For r in T do:
   Label r
Initialize: Randomly select s records from S and call this sample S₀
Update A to S₀
For r in S₀ do:
   Label r
Update U by removing S₀: U=U \ S0
Train model M with S₀; the trained model is now called m0
For 1 in [0, L−2] do:
   Run inferences on U using m
   Sort U by increasing order of confidence level (from the inference/prediction)
   Select the top s records from U and call this sample Sₗ₊₁
   For r in Sₗ₊₁ do
      Label r
   Update U by removing Sₗ₊₁: U=U \ Sₗ₊₁
   Update A by adding Sₗ₊₁: A=A union Sₗ₊₁
   Train model M with A; the trained model is now called mₗ₊₁

The bolded portion indicates the core of the querying strategy. The illustrated strategy includes a confidence-level based strategy that can be readily expressed in mathematical terms. However, the optimal subsample S₁ might not be easily expressed in a formula, as it might be, for example, the output of complex multi-objective optimization functions.

This disclosure describes a simple greedy algorithm that includes greedily selecting multiple subsets of similar size at each loop, and then picking the subset that yields the best results.

Example Algorithm: Greedy Querying Strategy Optimization Algorithm
L in the number of loops
P in the number of experiments/trials for each loop
Take the entire unlabeled training set D and split into the training set S and the test set T
Initialize set of unused data records U to S: U=S
Initialize active training set A to the empty set
For r in T do
   Label r
For 1 in [1, L] do:
   For p in [1, P] do:
   Initialize B_{1, p} to A
   Randomly select s records from U and call this sample S_{1, p}
      For r in S_{1, p} do:
         Label r
      Train model M with A ∪ S_{1, p}; the trained model is now called m_{1, p}
      Evaluate model accuracy a_{1, p} of m_{1, p} on T
   Select the sample q for which a_{1, p} is maximal: q=argmaxₚ(a_{1, p})
   Update U by removing S_{1, q}: U=U \ S_{1, q}
   Update A by adding S₁: A=A ∪ S_{1, q}

Another strategy includes a reinforcement learning-based algorithm relying on the computation of a reward function as a criterion for the search of optimality. An approach very similar to the greedy approach can be used to “explore” better data samples (samples containing more informative data records) within the training set (and hence, better querying strategies). Instead of using simple replacement (e.g., instead of putting all unselected data records back in the unlabeled data pool after each loop), it is possible to “remember” which samples, and hence which records, led to worse results, and reduce the probably with which they will be selected in the future by setting lower “weights”. This particular technique, for example, relies on Thompson Sampling and applies the technique to Active Learning. The updated weights can then be used to compute a reward function.

Example Algorithm: Reinforcement-Learning Based Querying Strategy Optimization
L in the number of loops
P in the number of experiments/trials for each loop
ε<1, penalty factor to reduce probability to select a specific record
wᵣ all originally set to 1.
Take the entire unlabeled training set D and split into the training set S and the test set T
Initialize set of unused data records U to S: U=S
Initialize active training set A to the empty set
For r in T do
   Label r
For 1 in [1, L] do:
   For p in [1, P] do:
   Initialize B_{1, p} to A
   Randomly select s records from U and call this sample S_{1, p}
      For r in S_{1, p} do:
         Label r
      Train model M with A ∪ S_{1, p}; the trained model is now called m_{1, p}
      Evaluate model accuracy a_{1, p} of m_{1, p} on T
   Select the sample q for which a_{1, p} is maximal: q=argmaxₚ(a_{1, p})
   For each sample p ≠ q do:
      For each record r in S_{1, p} do:
         wᵣ=ε×wᵣ(1)
   Update U by removing S_{1, q}: U=U \ S_{1, q}
   Update A by adding S₁: A=A ∪ S_{1, q}
(1) Note that (1) can be replaced by many alternatives:
   wᵣ=ε×wᵣ if r ∉ S_{i, q}
   wᵣ=ε×wᵣ if r is not an element of any of the top “k” samples

It is possible to randomly tweak the weights (reduce the penalty) in order to “re-explore” specific records.

Determination of a querying strategy path may be exemplified by the following example algorithm.

Example Algorithm: Dynamic Querying Strategy Selection
Q is the space of querying strategies considered and is fixed and predetermined.
Take a sample D entire unlabeled training set E and split into the training set S and the test set T
Initialize set of unused data records U to S: U=S
Initialize active training set A to the empty set
Initialize QP to the null list: QP=[ ]
For r in T do
   Label r
For 1 in [1, L] do:
   For qs in Q do:
   Initialize B_{1, qs} to A
   Apply qs on U to select s records and call this sample S_{1, qs}
      For r in S_{1, qs} do:
         Label r
      Train model M with A ∪ S_{1, qs}; the trained model is now called m_{1, qs}
      Evaluate model accuracy a_{1, qs} of m_{1, qs} on T
   Select the querying strategy q for which a_{1, p} is maximal: q=argmaxₚ(a_{1, qs})
   Append q to QP
   Update U by removing S_{1, q}: U=U \ S_{1, q}
   Update A by adding S₁: A=A ∪ S_{1, q}
Run Active Learning by applying the same query path QP on the entire dataset E

Besides the new concept of querying strategy path (QSP) (e.g., a dynamic, adaptive querying strategy that contrasts with traditional pre-established, static querying strategies usually used in Active Learning that are usually determined and chosen manually by a human), the disclosed system is also capable of learning (determining or training) a specific querying strategy path on a subset of a dataset, or on some historical dataset before generalizing the QSP to the entire/new dataset. The idea is to determine a more appropriate querying strategy on a sample before applying it on a large dataset.

Benefits of the disclosure include reducing the amount of training data needed when training a Machine Learning algorithm, with the intent of reducing (including, but not limited to): training time, computer power resources, labeling costs, storage costs, human labor costs (in particular, the size of DevOps teams). It is also capable of reducing over-fitting and improving model accuracy.

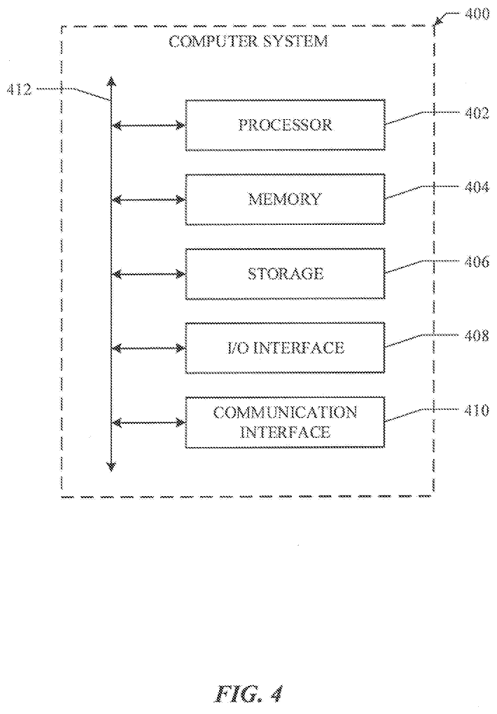

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

The above-described techniques may be implemented by one or more computer systems. This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method, as shown and described in any one or more of the drawing figures and/or any one or more paragraphs of the written description.

2. A computer-implemented method comprising:
receiving unlabeled training set data;
processing the unlabeled training set data using a selection process to yield a labeled training set;
training a machine learning model using the labeled training set;
inferring metadata elements from the model and storing metadata based on the model;
iterating the foregoing steps two or more times, including using the metadata to influence how other unlabeled training set data is selected;
all of the foregoing implementing one or more of: data and model privacy; optimal initialization; early abort; multi-loop querying strategy; dynamic-evolving querying strategy; querying strategy memorization; optimization and tuning.

3. A computer system comprising:
one or more hardware processors;
one or more computer-readable storage media storing instructions which, when executed using the one or more hardware processors, cause the one or more hardware processors to perform: receiving unlabeled training set data;
processing the unlabeled training set data using a selection process to yield a labeled training set;
training a machine learning model using the labeled training set;
inferring metadata elements from the model and storing metadata based on the model;
iterating the foregoing steps two or more times, including using the metadata to influence how other unlabeled training set data is selected;
all of the foregoing implementing one or more of: data and model privacy; optimal initialization; early abort; multi-loop querying strategy; dynamic-evolving querying strategy; querying strategy memorization; optimization and tuning.
